(19) United States
(12) Patent Application Publication
(10) Pub. No.: US 2024/0061650 A1
(43) Pub. Date: Feb. 22, 2024

(54) Floating-Point Execution Circuitry for Subset of Binary Logarithm Input Range

(71) Applicant: Apple Inc., Cupertino, CA (US)

(72) Inventors: Liang-Kai Wang, Austin, TX (US); Ian R. Ollmann, Los Gatos, CA (US); Anthony Y. Tai, San Jose, CA (US)

(21) Appl. No.: 17/820,766

(22) Filed: Aug. 18, 2022

(51) Int. Cl. G06F 7/556; G06F 7/487

(52) U.S. Cl. CPC G06F 7/556; G06F 7/4873

(57) ABSTRACT

Techniques are disclosed relating to polynomial approximation of the base-2 logarithm. In some embodiments, floating-point circuitry is configured to perform an approximation of a base-2 logarithm operation and provide a fixed unit of least precision (ULP) error over a range of inputs. In some embodiments, the floating-point circuitry includes a set of parallel pipelines for polynomial approximation, where the output is chosen from a particular pipeline based on a determination of whether the input operand is in a first subset of a range of inputs. Disclosed techniques may advantageously provide fixed ULP error for an entire input operand range for the floating-point base-2 logarithmic function with minimal area and energy footprint, relative to traditional techniques.

### BACKGROUND

### Technical Field

This disclosure relates generally to floating-point execution circuitry and more particularly to execution circuitry configured to approximate a binary logarithm operation.

### Description of the Related Art

Generally, the nature of certain functions and the format of a floating-point number may cause significant accuracy loss during polynomial approximation, e.g., when the result of a non-linear function is very close to 1.0. Uniform unit-of-least precision (ULP) error across an entire input range for a function may be desirable in various contexts but may be challenging to implement in the context of typical area and power constraints.

### BRIEF DESCRIPTION OF THE DRAWINGS

FIG. 1 is a block diagram illustrating an overview of example floating-point circuitry, according to some embodiments.

FIG. 2 is a block diagram illustrating detailed example floating-point circuitry with parallel pipelines for different ranges of an input operand, according to some embodiments.

FIG. 3A is a diagram illustrating an example first subset of an input range, according to some embodiments.

FIG. 3B is a diagram illustrating an example second subset of an input range, according to some embodiments.

FIG. 4 is a diagram illustrating an example base-2 logarithm function, according to some embodiments.

FIG. 5 is a flow diagram illustrating an example method for performing floating-point approximations of a base-2 logarithm, according to some embodiments.

FIG. 6 is a block diagram illustrating an example computing device, according to some embodiments.

FIG. 7 is a diagram illustrating example applications of disclosed systems and devices, according to some embodiments.

FIG. 8 is a block diagram illustrating an example computer-readable medium that stores circuit design information, according to some embodiments.

### DETAILED DESCRIPTION

For certain non-linear functions, significant accuracy may be lost when performing polynomial approximation when that function crosses (or is very close to) 1.0. The base-2 logarithm (also referred to as the binary logarithm) is one such function that exhibits this behavior for floating-point numbers represented in a binary format. For example, for a range of input values near 1.0, the base-2 logarithm may exhibit large ULP error relative to inputs outside of that range. In this context, adding circuitry (e.g., to perform a higher-level polynomial approximation or some other more complex approximation) may mitigate these issues, but may be infeasible and cost prohibitive in real-world applications.

In some embodiments, discussed in detail below, floating-point circuitry may include a set of parallel pipelines that operate on input operands to generate a polynomial approximation of a base-2 logarithm, select an output from the set of parallel pipelines based on the range in which the input operand falls, and recompose the output as a floating-point approximation of the base-2 logarithm result. Note that one of the pipelines may be clock or power gated when the input is in a range handled by the other pipeline in order to reduce power consumption.

Disclosed techniques may advantageously increase accuracy of polynomial approximation for the base-2 logarithm for a set of inputs that may exhibit low accuracy with traditional techniques. Disclosed techniques may also provide fixed ULP error for an entire input operand range for the floating-point base-2 logarithmic function without substantial area and energy footprint.

### Overview of Floating-Point Circuitry

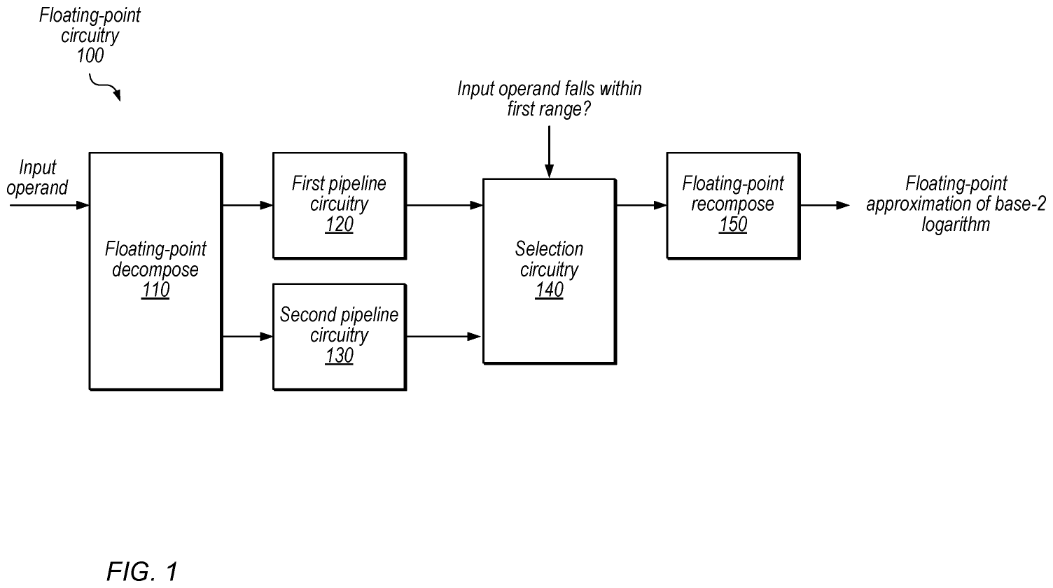

FIG. 1 is a block diagram illustrating an overview of example floating-point circuitry, according to some embodiments. In the illustrated embodiment, floating-point circuit 100 includes floating-point decompose circuitry 110, first pipeline circuitry 120, second pipeline circuitry 130, selection circuitry 140, and floating-point recompose circuitry 150.

In the illustrated embodiment, floating-point decompose circuitry 110 is configured to decompose a floating-point input operand into its basic fixed-point components, including the sign, exponent, and mantissa, for example. In some embodiments, in addition to separating the components from one another, decomposition may include converting one of the components (e.g., mantissa, exponent, etc.) to another format (e.g., two's complement format).

In some embodiments, input operands may be classified as either falling in a first subset of a range of inputs or in a second subset of a range of inputs. In some embodiments, the first subset includes the value 1.0. In some embodiments, the second subset of a range of inputs includes both values greater than one or more values in the first subset and values less than one or more values in the first subset. In some embodiments, the first and second subsets of the range of inputs are nonoverlapping.

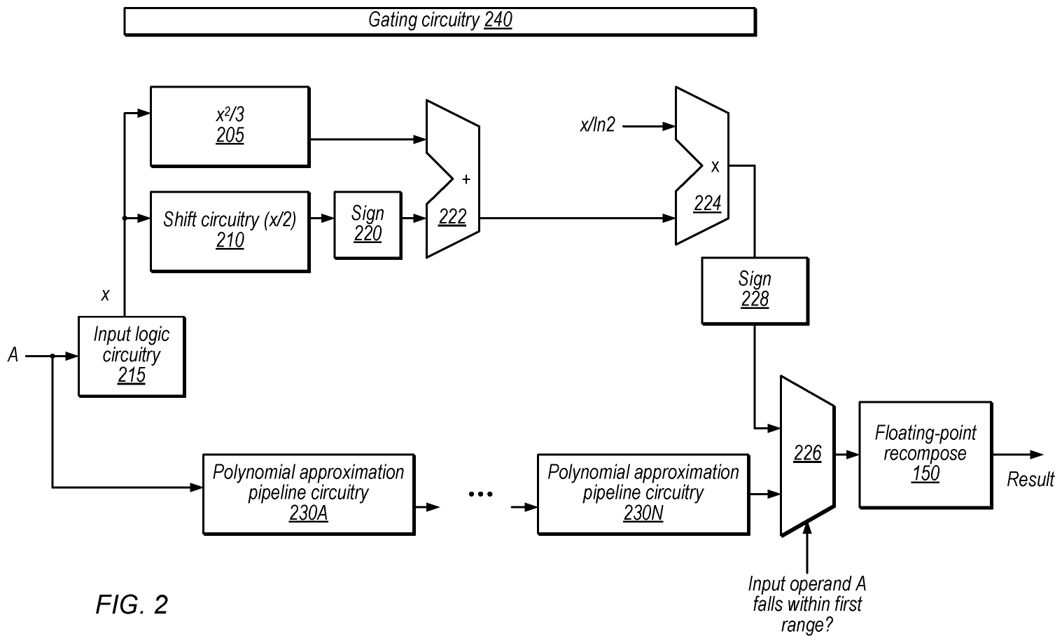

In the illustrated embodiment, first pipeline circuitry 120 is configured to perform an approximation of the base-2 logarithm for the input operand and output the result to selection circuitry 140. In some embodiments, the approximation of the base-2 logarithm may include performing a natural logarithm operation, a multiply operation, and a second-order or greater polynomial operation, discussed in detail below with reference to FIG. 2.

In the illustrated embodiment, second pipeline circuitry 130 is configured to perform an approximation of the base-2 logarithm for the input operand and output the result to selection circuitry 140. In various embodiments, second pipeline circuitry may use a different algorithm than first pipeline circuitry 120. For example, second pipeline circuitry 130 may implement a third-order polynomial approximation, in some embodiments in which the first pipeline circuitry 120 implements a natural logarithm and a second-order polynomial. For example, second pipeline circuitry 130 may be configured to perform a polynomial approximation with coefficients determined based on running a polyfit function on the binary logarithm. These coefficients may be stored in hardware (e.g., using a look-up table) during a processor design phase and accessed during operation of the processor based on the value of an input operand.

In the illustrated embodiment, selection circuitry 140 is configured to select, based on a determination of whether the input operand falls within the first subset of a range of inputs, between the outputs of first pipeline circuitry 120 and second pipeline circuitry 130. In some embodiments, based on a determination that the input operand falls within the first subset of a range of inputs near 1.0, selection circuitry 140 is configured to select the output of first pipeline circuitry 120.

In the illustrated embodiment, floating-point recompose circuitry 150 is configured to generate a floating-point approximation of the base-2 logarithm based on fixed-point inputs. In some embodiments, floating-point recompose circuitry 150 receives as input, from selection circuitry 140, an output of one of either first pipeline circuitry 120 or second pipeline circuitry 130, e.g., in embodiments in which the pipelines 120 and 130 operate on a mantissa of the input operand.

### Example Detailed Floating-Point Circuitry

FIG. 2 is a block diagram illustrating detailed floating-point circuitry, according to some embodiments. In the illustrated example, the first pipeline 120 for the subset of inputs near 1.0 includes

$$\frac{{x}^{2}}{3}$$

circuitry 205, shift circuitry 210, input logic circuitry 215, sign circuitry 220, adder 222, multiplier 224, and sign circuitry 228. The second pipeline 130 includes stages 230A-230N and selection circuitry 140 is implemented by MUX 226, in this example. Sign circuitry 220 and 228 are configured to properly correct the sign, if needed, as discussed in detail below.

In the illustrated example, the first pipeline is configured to implement the equation:

$${( - 1 )}^{AisLT 1.} \times \frac{x}{ln 2} \times ( 1 + {( - 1 )}^{AisGE 1.} \times \frac{x}{2} + \frac{{x}^{2}}{3} ) .$$

This equation may advantageously provide a good approximation for the function near 1.0 with limited circuit area and power consumption.

In this example, AisLT1.0 and AisGE1.0 refer to binary values that indicate whether the input operand A is less than 1.0 or greater than or equal to 1.0, respectively. For example, for an input operand A greater than or equal to 1.0, first pipeline is configured to implement the equation

$$\frac{x}{ln 2} \times ( 1 - \frac{x}{2} + \frac{{x}^{2}}{3} ) ,$$

where A=1+x and the result is always positive. Similarly, for an input operand A less than 1.0, first pipeline is configured to implement the equation

$$- \frac{x}{ln 2} \times ( 1 + \frac{x}{2} + \frac{{x}^{2}}{3} ) ,$$

where A=1−x and the result is always negative. In some embodiments, input operand A represents a mantissa.

In the illustrated embodiment, input logic circuitry 215 receives, as input, input operand A and computes a value x based on whether input operand A is less than 1.0 or greater than or equal to 1.0. In some embodiments, when input operand A is greater than or equal to 1.0, input logic circuitry 215 computes and outputs x=A−1. In some embodiments, when input operand A is less than 1.0, input logic circuitry 215 computes and outputs x=1−A. In some embodiments, input logic circuitry 215 includes a comparator circuit configured to compare A with the value 1.0.

In the illustrated example, the x/2 operand is generated by shift circuitry 210 with the sign value generated by sign circuitry 220. In the illustrated example, the

$$\frac{{x}^{2}}{3}$$

operand is generated by

$$\frac{{x}^{2}}{3}$$

circuitry 205. In some embodiments,

$$\frac{{x}^{2}}{3}$$

circuitry 205 includes a square unit to compute x². In some embodiments, the divide by three operation is performed by multiplier circuitry that multiplies x² by the reciprocal of divide by three (e.g., multiply by ⅓). In some embodiments, the reciprocal value is stored as a constant, e.g., in a register. The polynomial expansion

$$( 1 - \frac{x}{2} + \frac{{x}^{2}}{3} )$$

is generated by adder 222. The operand x/ln 2 is an input to multiplier 224. In some embodiments, the x/ln 2 operand is computed using a multiplier unit, where the reciprocal of ln 2 is one multiplier input and x is the other multiplier input. In some embodiments, the reciprocal of ln 2 is stored in a register. In the illustrated example, the output of adder 222 multiplied by the operand x/ln 2 using multiplier 224, generates the output of the equation above; with the sign value determined by sign circuitry 228.

In the illustrated embodiment,

$$\frac{{x}^{2}}{3}$$

circuitry 205 is configured to compute the square of the input x and divide it by 3.

$$\frac{{x}^{2}}{3}$$

circuitry 205 receives, as input, an input x.

In the illustrated embodiment, shift circuitry 210 is configured to perform a shift operation on the input x to generate a value of x/2. The result of the shift operation performed by shift circuitry 210 is propagated to sign circuitry 220.

In the illustrated embodiment, sign circuitry 220 is configured to perform a sign operation on an input and generate an output. In some embodiments, when input operand A is less than 1.0 (e.g., as determined by input logic circuitry 215), sign circuitry 220 may negate the input received from shift circuitry 210, which is equivalent to a multiplication operation by a factor of negative 1. In some embodiments, sign circuitry 220 includes an inverter circuit to perform the negation operation (e.g., by inverting bits of the input and adding one for two's complement representations). In some embodiments, when input operand A is greater than or equal to 1.0, sign circuitry 220 may propagate the input received from shift circuitry 210 to adder circuit 222 without performing any operations on the input.

In the illustrated embodiment, adder circuit 222 is configured to perform an addition operation on the outputs from

$$\frac{{x}^{2}}{3}$$

circuitry 205 and sign circuitry 220. In some embodiments, the result of the addition operation is propagated to multiplier circuit 224.

In the illustrated embodiment, multiplier circuit 224 is configured to perform a multiplication operation on the adder output and an input x/ln 2, the result of which is propagated to sign circuitry 228. In some embodiments, sign circuitry 228 is configured to conditionally reverse the sign of its input, as discussed above with reference to sign circuitry 220.

In some embodiments,

$$\frac{{x}^{2}}{3}$$

circuitry 205, shift circuitry 210, sign circuitry 220, sign circuitry 228, adder circuit 222, and multiplier circuit 224 are elements included in first pipeline circuitry 120.

In the illustrated embodiment, polynomial approximation pipeline circuitry 230A-230N is configured to perform a polynomial approximation of a base-2 logarithm based on an input operand A. In some embodiments, polynomial approximation pipeline circuitry 230A-230N is included in second pipeline circuitry 130.

In some embodiments, polynomial approximation pipeline circuitry 230A-230N performs the polynomial approximation of the base-2 logarithm in a cascade of multiplication and addition operations that utilize a polynomial coefficient table. For example, the polynomial approximation may be a 2^{nd} order polynomial of the form: log₂ A≈((A*C0+C1)*A+C2). As another example, the polynomial approximation may be a 3^{rd} order polynomial of the form: log₂ A≈((A*C0+C1)*A+C2)*A+C3. In these examples, coefficients C0-C3 are retrieved from the polynomial coefficient table and used in multiple add/multiply operations to generate the base-2 logarithm approximation. In other embodiments, a 2^{nd} order or higher polynomial approximation may be performed.

In the illustrated embodiment, multiplexor circuit 226 provides an output selected from the two inputs received from sign circuitry 228 and polynomial approximation pipeline circuitry 230N, based on whether the input operand A falls within a first subset of a range of inputs.

In some embodiments, in response to the input operand A being in a first subset of a range of inputs, the multiplexor circuit may select the result of the polynomial approximation propagated by sign circuitry 228. In some embodiments, in response to the input operand A not being in a first subset of a range of inputs, the multiplexor circuit may select the result of the polynomial approximation generated by polynomial approximation pipeline circuitry 230N.

In the illustrated embodiment, floating-point recompose circuitry 150 is configured to perform a floating-point recomposition based on the fixed-point value received from the multiplexor circuit, to generate a floating-point result.

In the illustrated embodiment, gating circuitry 240 is configured to power down one or more elements based on whether the input operand A falls within a first subset of a range of inputs. For example, gating circuitry 240 may power down polynomial approximation pipeline circuitry 230A-230N in response to input operand A being in a first subset of a range of inputs. This may advantageously provide fixed ULP error for an entire input operand range without substantial energy footprint.

### Example Input Ranges

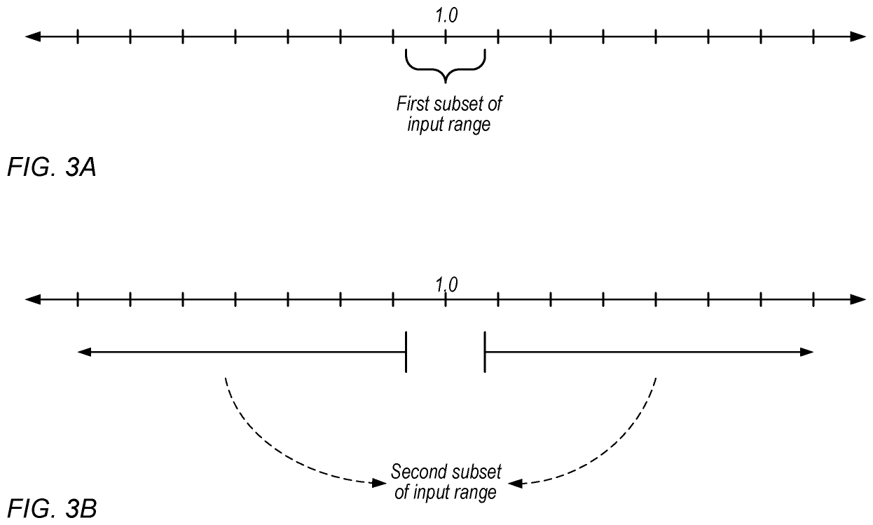

FIG. 3A is a diagram illustrating an example first subset of an input range, according to some embodiments. In the illustrated embodiment, a first subset of a range of inputs includes a range of values that includes the value 1.0.

FIG. 3B is a diagram illustrating an example second subset of an input range, according to some embodiments. In the illustrated embodiment, a second subset of a range of inputs includes values greater than one or more values in the first subset and less than one or more values in the first subset.

In some embodiments, the first and second subsets of the range of inputs are nonoverlapping.

### Example Base-2 Logarithm

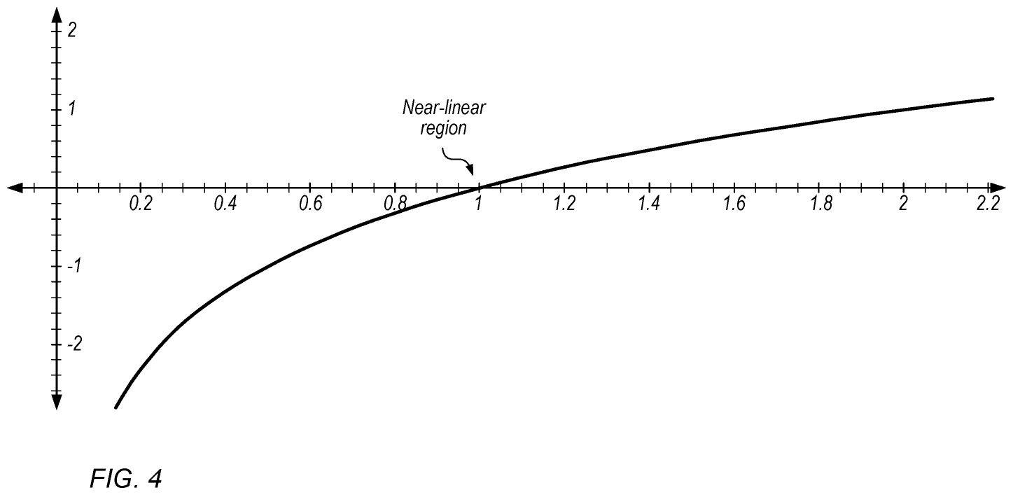

FIG. 4 is a diagram illustrating an example base-2 logarithm function, according to some embodiments. In the illustrated embodiment, the base-2 logarithm (also known as the “binary logarithm”) is a non-linear function that finds the power to which the number 2 must be raised to obtain the value n, e.g., x=log₂ n.

In some embodiments, for inputs very close to or equal to 1.0, the base-2 logarithm exhibits an almost linear relationship. This region may be referred to as the near-linear region. Disclosed techniques that utilize first pipeline circuitry 120 for inputs in this region and second pipeline circuitry 130 for other regions may achieve various advantages discussed in detail above.

### Example Method

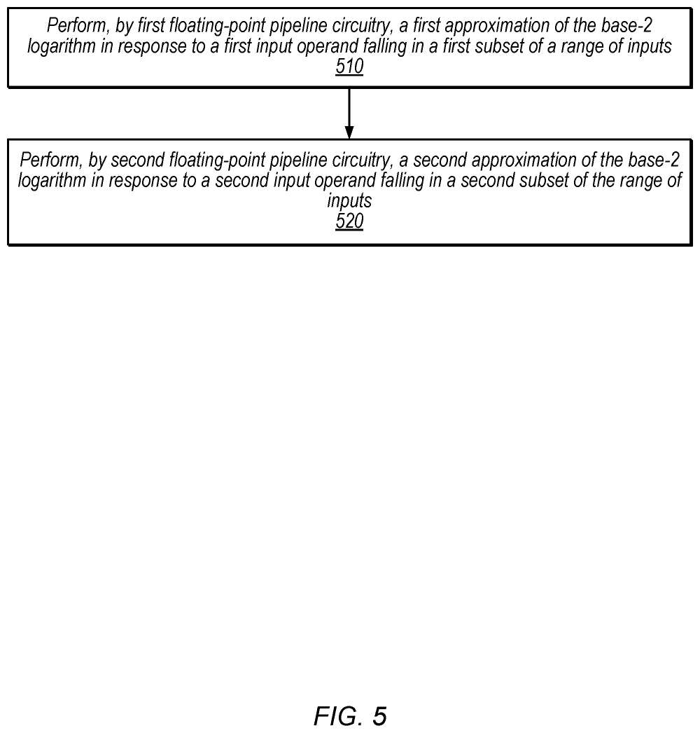

FIG. 5 is a flow diagram illustrating an example method for performing floating-point approximations of a base-2 logarithm, according to some embodiments. The method shown in FIG. 5 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 510, in the illustrated embodiment, first floating-point pipeline circuitry performs a first approximation of a base-2 logarithm in response to a first input operand falling in a first subset of a range of inputs.

In some embodiments, the first approximation of the base-2 logarithm may include to perform a natural logarithm operation, a multiply operation, and a second-order or greater polynomial operation.

In some embodiments, the second-order or greater polynomial operation is a portion of a Taylor series expansion. In some embodiments, shift circuitry implements one or more division operations for the polynomial operation. In some embodiments, the first subset of a range of inputs includes a range of values that includes the value 1.0. In some embodiments, first floating-point pipeline circuitry performs fixed-point operations on a mantissa of an input operand.

In some embodiments, fixed-point to floating-point circuitry performs a recomposition of output data from first floating-point pipeline circuitry to generate a floating-point result.

At 520, in the illustrated embodiment, second floating-point pipeline circuitry performs a first approximation of a base-2 logarithm in response to a second input operand falling in a second subset of a range of inputs.

In some embodiments, the second approximation of the base-2 logarithm may include to perform a polynomial approximation with coefficients determined based on running a polyfit function on a binary logarithm.

In some embodiments, the second subset of the range of inputs includes values greater than one or more values in the first subset and less than one or more values in the first subset.

In some embodiments, the first and second subsets of the range of inputs are nonoverlapping.

### Example Device

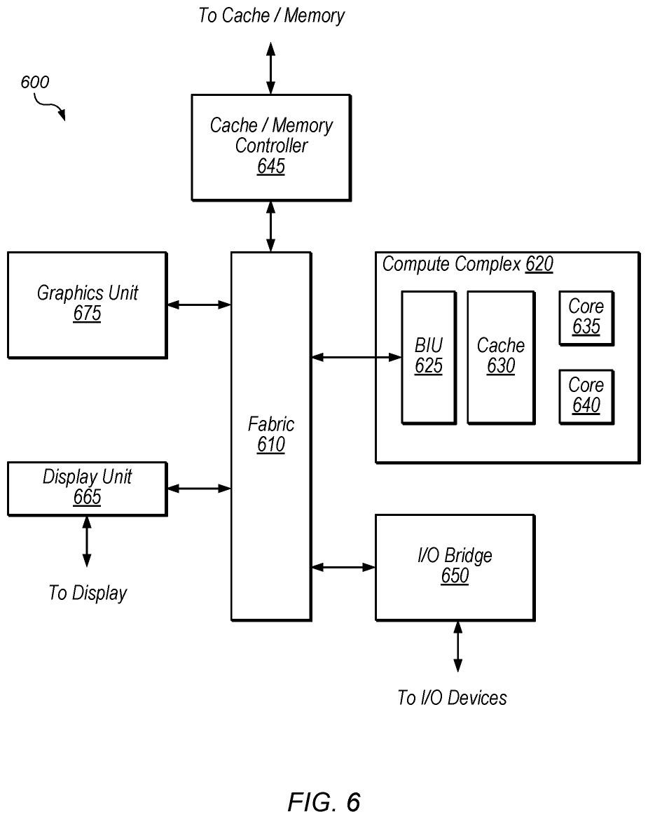

Referring now to FIG. 6, a block diagram illustrating an example embodiment of a device 600 is shown. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620 input/output (I/O) bridge 650, cache/memory controller 645, graphics unit 675, and display unit 665. In some embodiments, device 600 may include other components (not shown) in addition to or in place of the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600 may be configured to maintain coherency between various caches of device 600. BIU 625 may be configured to manage communication between compute complex 620 and other elements of device 600. Processor cores such as cores 635 and 640 may be configured to execute instructions of a particular instruction set architecture (ISA) which may include operating system instructions and user application instructions.

Cache/memory controller 645 may be configured to manage transfer of data between fabric 610 and one or more caches and memories. For example, cache/memory controller 645 may be coupled to an L3 cache, which may in turn be coupled to a system memory. In other embodiments, cache/memory controller 645 may be directly coupled to a memory. In some embodiments, cache/memory controller 645 may include one or more internal caches.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Graphics unit 675 may include one or more processors, e.g., one or more graphics processing units (GPU's). Graphics unit 675 may receive graphics-oriented instructions, such as OPENGL®, Metal, or DIRECT3D® instructions, for example. Graphics unit 675 may execute specialized GPU instructions or perform other operations based on the received graphics-oriented instructions. Graphics unit 675 may generally be configured to process large blocks of data in parallel and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry which may include highly parallel execution cores configured to execute graphics programs, which may include pixel tasks, vertex tasks, and compute tasks (which may or may not be graphics-related).

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement: universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 650.

In some embodiments, device 600 includes network interface circuitry (not explicitly shown), which may be connected to fabric 610 or I/O bridge 650. The network interface circuitry may be configured to communicate via various networks, which may be wired, wireless, or both. For example, the network interface circuitry may be configured to communicate via a wired local area network, a wireless local area network (e.g., via WiFi), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth or WiFi Direct), etc. In various embodiments, the network interface circuitry may provide device 600 with connectivity to various types of other devices and networks.

### Example Applications

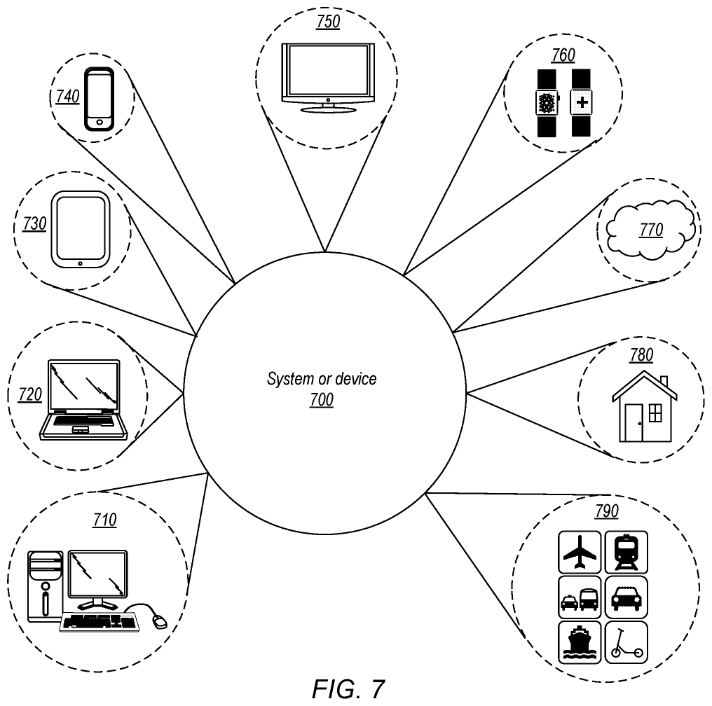

Turning now to FIG. 7, various types of systems that may include any of the circuits, devices, or system discussed above. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a fabrication system configured to produce hardware (e.g., an integrated circuit) that includes the disclosed circuitry. Claims to such a storage medium are intended to cover, for example, an entity that produces a circuit design, but does not itself fabricate the design.

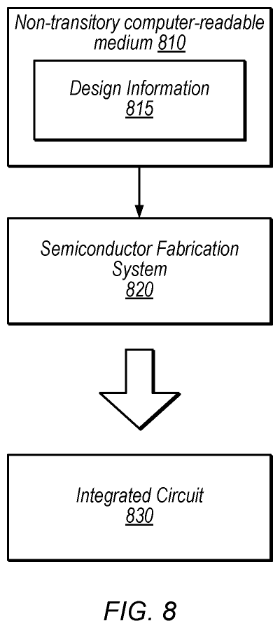

FIG. 8 is a block diagram illustrating an example non-transitory computer-readable storage medium that stores circuit design information, according to some embodiments. In the illustrated embodiment semiconductor fabrication system 820 is configured to process the design information 815 stored on non-transitory computer-readable medium 810 and fabricate integrated circuit 830 based on the design information 815.

Non-transitory computer-readable storage medium 810, may comprise any of various appropriate types of memory devices or storage devices. Non-transitory computer-readable storage medium 810 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 810 may include other types of non-transitory memory as well or combinations thereof. Non-transitory computer-readable storage medium 810 may include two or more memory mediums which may reside in different locations, e.g., in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. Design information 815 may be usable by semiconductor fabrication system 820 to fabricate at least a portion of integrated circuit 830. The format of design information 815 may be recognized by at least one semiconductor fabrication system 820. In some embodiments, design information 815 may also include one or more cell libraries which specify the synthesis, layout, or both of integrated circuit 830. In some embodiments, the design information is specified in whole or in part in the form of a netlist that specifies cell library elements and their connectivity. Design information 815, taken alone, may or may not include sufficient information for fabrication of a corresponding integrated circuit. For example, design information 815 may specify the circuit elements to be fabricated but not their physical layout. In this case, design information 815 may need to be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. As used herein, mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 is configured to operate according to a circuit design specified by design information 815, which may include performing any of the functionality described herein. For example, integrated circuit 830 may include any of various elements shown in FIGS. 1 and 6. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method). _p ***

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. §112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
floating-point circuitry configured to perform an approximation of a base-2 logarithm operation and provide a fixed unit of least precision (ULP) error over a range of inputs, wherein the floating-point circuitry comprises:
first pipeline circuitry configured to perform the approximation of the base-2 logarithm for input operands in a first subset of the range of inputs; and
second pipeline circuitry configured to perform the approximation of the base-2 logarithm for input operands in a second subset of the range of inputs; and
selection circuitry configured to select a result of either the first pipeline or the second pipeline based on whether a given input operand is in the first subset of the range of inputs.

2. The apparatus of claim 1, wherein, to perform the approximation of the base-2 logarithm, the first pipeline circuitry is configured to perform a natural logarithm operation.

3. The apparatus of claim 2, wherein, to perform the approximation of the base-2 logarithm, the first pipeline circuitry is further configured to perform a second-order or greater polynomial operation.

4. The apparatus of claim 3, wherein the polynomial operation is a portion of a Taylor series expansion.

5. The apparatus of claim 3, further comprising:
shift circuitry configured to implement one or more division operations for the polynomial operation.

6. The apparatus of claim 1, wherein the first subset of the range of inputs includes a range of values that includes the value 1.0.

7. The apparatus of claim 1, wherein the first and second subsets of the range of inputs are nonoverlapping and the second subset of the range of inputs includes values greater than one or more values in the first subset and less than one or more values in the first subset.

8. The apparatus of claim 1, wherein the first pipeline circuitry is configured to perform fixed-point operations on a mantissa of an input operand.

9. The apparatus of claim 8, further comprising:
fixed-point to floating-point circuitry configured to recompose output data from the first pipeline to generate a floating-point result.

10. The apparatus of claim 1, wherein the apparatus is a computing device that further includes:
a display;
a central processing unit; and
network interface circuitry.

11. A method, comprising:
performing, by first floating-point pipeline circuitry, a first approximation of a base-2 logarithm in response to a first input operand falling in a first subset of a range of inputs; and
performing, by second floating-point pipeline circuitry, a second approximation of the base-2 logarithm in response to a second input operand falling in a second subset of the range of inputs.

12. The method of claim 11, further comprising:
performing, by first pipeline circuitry, a natural logarithm operation for first the approximation of the base-2 logarithm.

13. The method of claim 12, further comprising:
performing, by first pipeline circuitry, a second-order or greater polynomial operation for the first approximation of the base-2 logarithm.

14. The method of claim 13, further comprising:
performing, by first pipeline circuitry, a portion of a Taylor series expansion for the polynomial operation.

15. The method of claim 11, wherein the first subset of a range of the range of inputs includes a range of values that includes the value 1.0.

16. The method of claim 11, wherein the second subset of the range of inputs includes values greater than one or more values in the first subset and less than one or more values in the first subset, and the first and second subsets of the range of inputs are nonoverlapping.

17. A non-transitory computer readable storage medium having stored thereon design information that specifies a design of at least a portion of a hardware integrated circuit in a format recognized by a semiconductor fabrication system that is configured to use the design information to produce the circuit according to the design, wherein the design information specifies that the circuit includes:
floating-point circuitry configured to perform an approximation of a base-2 logarithm operation and provide a fixed unit of least precision (ULP) error over a range of inputs, wherein the floating-point circuitry comprises:
first pipeline circuitry configured to perform the approximation of the base-2 logarithm for input operands in a first subset of the range of inputs; and
second pipeline circuitry configured to perform the approximation of the base-2 logarithm for input operands in a second subset of the range of inputs; and
selection circuitry configured to select a result of either the first pipeline or the second pipeline based on whether a given input operand is in the first subset of the range of inputs.

18. The non-transitory computer readable storage medium of claim 17, wherein to perform the approximation of the base-2 logarithm, first pipeline circuitry is configured to perform a natural logarithm operation.

19. The non-transitory computer readable storage medium of claim 18, wherein to perform the approximation of the base-2 logarithm, the first pipeline is further configured to perform a second-order or greater polynomial operation.

20. The non-transitory computer readable storage medium of claim 17, wherein the first subset of the range of inputs includes a range of values that includes the value 1.0.
